(19) United States
(12) Patent Application Publication
(10) Pub. No.: US 2023/0407975 A1
(43) Pub. Date: Dec. 21, 2023

(54) ACTUATING DEVICE FOR USE IN SANITARY INSTALLATIONS

(71) Applicant: Neoperl GmbH, Müllheim (DE)

(72) Inventor: Adrijan STRMSEK, Maribor (SI)

(73) Assignee: Neoperl GmbH, Müllheim (DE)

(21) Appl. No.: 17/842,883

(22) Filed: Jun. 17, 2022

(51) Int. Cl. F16K 11/07; E03C 1/02; F16K 11/22; E03C 1/04; F16K 31/44

(52) U.S. Cl. CPC F16K 11/0704; E03C 1/023; F16K 11/22; E03C 1/0408; F16K 31/44

(57) ABSTRACT

In order to improve the operating properties of an actuating device (1) for opening water routes (53) of a sanitary installation (52), the actuating device (1) has a locking mechanism (22) having at least one movable locking element (23), by way of which locking mechanism (22) at least two actuating elements (8) of the apparatus (1) which serve to actuate associated valves (3) can be locked releasably in a respective actuating position (30). The actuating device (1) also has a separate release actuating element (4), by way of which a locking state of each of the remaining at least two actuating elements (8) can be released.

### TECHNICAL FIELD

The invention relates to an actuating device for actuating individual valves of a valve arrangement. To this end, the actuating device has at least two actuating elements. The actuating elements can be operated manually, and therefore allow an activation/actuation of a respective one of the valves, in order thus to open or to close the valves by way of actuation of the actuating elements.

Furthermore, the invention relates to the use of an actuating device of this type, and to a sanitary installation which has an actuating device of this type.

### BACKGROUND

Actuating devices of this type are previously known per se in the prior art and are used, in particular, to switch on and off various water routes by the valves. A set object of this type is set for instance in bathrooms, where various outlets of a sanitary fitting are to be supplied with water by an actuating device as explained at the outset.

### SUMMARY

Proceeding herefrom, the invention is based on the object of making improved handling and actuation of valves of a valve arrangement possible, which is firstly user-friendly and secondly complies with the legal and normative regulations.

One or more of the features disclosed herein are provided to achieve this object in the case of an actuating device. It is therefore proposed according to the invention to achieve the object in the case of an actuating device of the type mentioned at the outset, in particular, that each of the at least two actuating elements is assigned a locking element, by way of which the respective actuating element can be locked, and that it is possible for the locking element to be transferred by a separate release actuating element from a locking position into a release position.

The actuating device can preferably be configured as a manual apparatus which can be actuated manually. The locking element can be of multiple-piece configuration in contrast; therefore, in particular, a plurality of separate locking elements can be configured, as will still be explained in more precise detail.

Here, the actuating device can comprise the valve arrangement with the valves and can be configured as one structural unit, in particular, together with the valve arrangement. The valves can also be configured as a structural unit consisting of a pilot valve and an associated main valve. In this case, the respective actuating element can switch the pilot valve, as a result of which the main valve can also be switched indirectly (for example, on account of an internal pressure rise in the main valve).

Here, the actuating elements can be guided in each case in a central guide element or in respective guide elements, for instance in order to allow only linear actuation.

In addition, both the actuating elements and the locking element can have associated restoring elements which restore the respective element with the aid of a restoring force (into the starting position in the case of an actuating element or into the release position in the case of the locking element). Restoring elements of this type can also be configured in one piece with the respective element.

Here, the release actuating element therefore acts as a release element and, in the case of activation, releases precisely the locking action which the locking element generates in the locking position.

It is advantageous in an embodiment of this type that comfortable immediate stopping of the water flow can be achieved by way of the actuating device by way of actuation of the release actuating element, to be precise independently of which of the actuating elements is currently locked in an actuating position, in which the associated valve is switched to conduct water. The release actuating element can therefore act/be understood as a global stop button for the water flow through the valve arrangement.

According to the invention, it is provided, furthermore, that each actuating element has a holding projection between its free end and its recess which interacts with the locking element, by way of which holding projection the locking element can be deflected.

Therefore, that section of the actuating element which deflects the locking element can be adjoined by the recess, by way of which the actuating element latches on the locking element.

According to the invention, it is provided, furthermore, that each actuating element is guided axially in the region of its holding projection.

Therefore, lateral tilting of the actuating element can be avoided. Tilting of the actuating element during its actuation might lead to it not being locked correctly.

According to the invention, the object can also be achieved by way of further advantageous embodiments as described below and in the claims.

The recess can thus, for example, be a peripheral groove.

Errors in the locking of the actuating element by way of an actuating element which is turned about its longitudinal axis can therefore be avoided.

It can also be provided that the recess defines the holding projection.

The recess therefore directly adjoins the holding projection, and the actuating element can be of particularly compact configuration.

For example, the locking element can be a global locking element which can lock all of the at least two actuating elements.

In accordance with one alternative embodiment, each of the at least two actuating elements can also be assigned a respective separate locking element. In this case, there are therefore a plurality of locking elements which can lock in each case only one or two of the at least two actuating elements. It is preferred in the case of embodiments of this type if it is possible for all of the locking elements to be transferred by the release actuating element into a respective release position, in order thus to ensure the global stop functionality.

In order to transfer a locking element into the release position, it is possible for the release actuating element to act, for example, directly on a global locking element or on a plurality of locking elements. This can take place, in particular, via a run-on slope which can be configured, for example, on the locking element and/or on the release actuating element.

It is also possible for each of the abovementioned separate locking elements to be transferred by a global release element into a respective release position. In the case of an embodiment of this type, the locking elements are therefore transferred jointly by the release element into the respective release position. Here, it is preferably possible for the release element for its part to be activated by the release actuating element, in particular via a run-on slope.

In accordance with one embodiment, the separate locking elements can be arranged radially in relation to the release actuating element and/or can be displaceable in radial directions into respective release positions. Here, the release actuating element can preferably be arranged in the center of the apparatus, with the result that the locking elements then move radially in relation to the release actuating element.

As an alternative, embodiments are also conceivable, in the case of which the separate locking elements are mounted such that they can be displaced along a common locking direction. This is appropriate, for example, in the case of a linear arrangement of the locking elements and/or the actuating elements.

Finally, the invention can also be realized in embodiments, in which the separate locking elements are pivotable about respective rotational axes into the respective locking position. In this case, the locking elements are therefore not configured as slide parts, but rather as pivoting parts.

The actuating elements can be transferable in each case from a starting position (which might also be called an OFF position) into an actuating position (which might also be called an ON position). In the actuating position, the actuating elements can act here on actuating elements of the associated valve in such a way that the valve is switched, that is to say, for example, is opened (for example, in the case of a self-closing valve). It goes without saying that embodiments with self-opening valves are also conceivable. In this case, the self-opening valves can be closed by the actuating elements (therefore, the valve would be closed when the associated actuating element is situated in the ON position/the actuating position).

Each of the at least two actuating elements can be fixable or fixed in the actuating position automatically by way of the associated locking element after transfer into the respective actuating position. That is to say, in the case of an embodiment of this type, the respective locking element ensures that the actuating element and the associated valve remains switched on, that is to say remains in the actuating position as soon as the latter is reached. In other words, an automatic return of the fixed actuating element into the starting position is prevented as a result. If the actuating element remains in the actuating position, a continuous flow through the associated and then open valve can remain ensured, for example (in the case of the use of a self-closing valve).

A respective locking element of the apparatus can therefore be movable from a respective locking position into a release position (preferably counter to a restoring force of a restoring element), the respective locking element fixing (that is to say holding in a stationary manner) the associated actuating element in the locking position. In contrast, the associated restoring element can convey the respective locking element from the release position into the locking position, in order thus to make automatic locking possible. Said starting position can therefore be understood to be an OFF position and, in contrast, the actuating position can be understood to be an ON position: the associated valve can thus be actuated in the actuating position. In the case of a self-closing valve, the actuating position would therefore be that position, in which the valve is open.

In accordance with a further possible embodiment, the apparatus can also be equipped with a blocking function: each of the at least two actuating elements can thus be assigned a respective blocking element (which can be configured separately from the associated locking element), by way of which an actuating movement of the respective actuating element can be blocked temporarily. This means that, in the blocked state, the actuating element can no longer be actuable, or at least cannot be actuable to a full extent. This can achieve a situation where an associated valve can no longer be switched by a blocked actuating element (the valve is therefore also blocked). Here, the blocking elements can be mounted in each case displaceably or else pivotably.

This blocking functionality can be configured, in particular, in such a way that, as soon as one of the at least two actuating elements is situated in a/the abovementioned actuating position, the actuation of all other ones of the at least two actuating elements is blocked. In the case of this type, it can be additionally provided that the respective blocking element can be transferred from a blocking position into a release position by way of actuation of one of the at least two actuating elements.

Furthermore, the apparatus can be configured in such a way that the respective blocking element can be transferred from a release position into a blocking position by way of actuation of the separate release actuating element. Therefore, in addition to the release function, that is to say the release of the locking action of the currently activated actuating element, the release actuating element can also perform a blocking function, namely by way of (temporary/terminable) blocking of individual, in particular all, actuating elements. If a locking state of an actuating element is therefore canceled by way of actuation of the release actuating element, temporary blocking of all the actuating elements can first of all be achieved as a result. This (global) blocking can then be canceled by virtue of the fact that one of the actuating elements is activated, as a result of which the associated blocking element is transferred from the blocking position into the release position. This can be accompanied by a transfer of other blocking elements from a release position into the blocking position, with the result that the activation of one of the actuating elements therefore leads to blocking of the remaining actuating elements.

The use of blocking elements can therefore achieve, in particular, a situation where always only at most one of the at least two actuating elements can be situated in the actuating position. This is appropriate, for example, if the water throughflow through the valve arrangement is intended to be limited by it being intended/possible for always only one of the at least two valves to be opened with the aid of the actuating device.

It can be provided, furthermore, that it is possible for each of the blocking elements to be transferred into a respective blocking position with the aid of the release actuating element. Here, in particular, the blocking elements can make contact with one another and can therefore activate one another.

In addition, or alternatively, it can also be provided that it is possible for an associated blocking element to be transferred from a blocking position into a release position by way of actuation of one of the at least two actuating elements when none of the actuating elements is currently locked with the aid of the associated locking element. Accordingly, in the case of an embodiment of this type, individual ones of the actuating elements (depending on the current actuating situation) can act as an unblocking element, by way of which a respective blocking element can be transferred into a releasing position.

In further other embodiments completely without a blocking functionality, it can be provided, in contrast, that the at least two actuating elements do not block mutually, with the result that a plurality of the at least two actuating elements can also simultaneously be situated in an/the actuating position. It can be made possible as a result that water can flow through a plurality of the valves at the same time.

Quite generally, the respective locking element can be configured to lock an associated actuating element in a positively locking manner. For instance, the locking element can have projections, for example also in the form of a hole edge, which can engage into associated recesses of the actuating elements, in order to generate the desired positively locking connection.

In particular, a holding projection can be configured to this end on the respective actuating element, into which holding projection the (associated) locking element can engage.

In most cases, the operability is improved if it is possible for the at least two fastening elements to be actuated manually along a common actuating direction. For example, the actuating elements can be configured as pushbuttons which can be actuated axially only along a defined direction.

The locking element, that is to say, in particular, the abovementioned separate locking elements, can then be mounted in such a way that it/they moves/move, during the transition into a/the locking position, in a plane which runs transversely with respect to the actuating direction of the actuating elements. As a result, lateral engaging of the respective locking element into the associated actuating element is made possible, as a result of which a robust locking action can be achieved.

It can be provided, furthermore, that it is possible for the locking element, in particular the separate locking elements, to move or pivot in a linear manner into a/the respective locking position. Here, an associated pivot axis can be oriented precisely in the actuating direction of the actuating elements, with the result that the respective locking element can move in a pivoting plane which is oriented transversely with respect to the actuating direction.

In accordance with a further possibility, the apparatus can also be configured in such a way that it is possible for the locking state to be released not only by way of the separate release actuating element, but rather that, in addition, it is possible for a locking state, caused by way of the locking element, of one of the actuating elements to be canceled by way of actuation of another non-locked one of the actuating elements. If, accordingly, one of the actuating elements is locked in an ON position, this locking state can be canceled by way of actuation of an adjacent non-locked actuating element (out of the OFF position).

To this end, the activated non-locked actuating element can have, in particular, a run-on slope, by way of which the locking element can be transferred into a/the release position.

Finally, in order to achieve the object mentioned at the outset, a sanitary installation is also proposed which can be configured, in particular, as a shower and/or bath fitting, and which has an actuating device as claimed in one of the claims directed to an actuating device or as described above.

It is therefore also proposed for an actuating device as described herein to be used precisely in a sanitary installation of this type, in order thus for it to be possible for the water flow to individual water outlets of the sanitary installation to be controlled.

### BRIEF DESCRIPTION OF THE DRAWINGS

The invention will now be described in greater detail on the basis of a plurality of exemplary embodiments, but is not restricted to these exemplary embodiments. Further embodiments of the invention can be gathered from the following description of one preferred exemplary embodiment in conjunction with the general description, the claims and the drawings.

In the following description of various preferred embodiments of the invention, elements which coincide in terms of their function are given identical designations even in the case of a different design or form.

In the drawings:

FIG. 1 shows the constituent parts of a first actuating device according to the invention including an associated valve arrangement,

FIG. 2 shows the apparatus from FIG. 1 in an assembled state,

FIG. 3 shows a lateral cross-sectional view of the apparatus from FIGS. 1 and 2,

FIGS. 4 to 9 and 10A-10I show further lateral cross-sectional views of the apparatus from FIGS. 1 and 2 in different actuating states,

FIG. 11 shows a sanitary installation in accordance with the prior art,

FIG. 12 shows a second actuating device according to the invention in a three-dimensional oblique view from above,

FIG. 13 shows the actuating device from FIG. 12 with a removed covering,

FIG. 14 shows the actuating device from FIG. 12 in a partially cut-away oblique view,

FIG. 15 shows a locking element of the actuating device from FIG. 12 in a locking position,

FIG. 16 shows a locking element of the actuating device from FIG. 12 in a release position,

FIG. 17 shows an exploded illustration of the actuating device from FIG. 12,

FIGS. 18A-18D show the movement sequence of an actuating element from the starting position in FIG. 18A into the actuating position in FIG. 18D in the case of the actuating device from FIG. 12,

FIGS. 19A-19D show the movement sequence of a release actuating element in the case of releasing of the locking mechanism, and the corresponding return movement of the locked actuating elements from the actuating position into the starting position,

FIG. 20 shows the constituent parts of a third actuating device according to the invention including an associated valve arrangement,

FIG. 21 shows the apparatus from FIG. 20 in an assembled state,

FIG. 22 shows an oblique partial cross-sectional view of the apparatus from FIGS. 20 and 21,

FIGS. 23A-23H show, in views 23A-23D, the movement sequence of an actuating element from the starting position into a locked actuating position in the case of the actuating device from FIG. 12, and, in views 23E-23H, the movement sequence of a release actuating element in the case of releasing of the locking mechanism, and the corresponding return movement of the locked actuating elements from the actuating position into the starting position,

FIG. 24 shows a fourth actuating device according to the invention in a three-dimensional oblique view, and

FIG. 25 shows an exploded illustration of the actuating device from FIG. 24.

### DETAILED DESCRIPTION

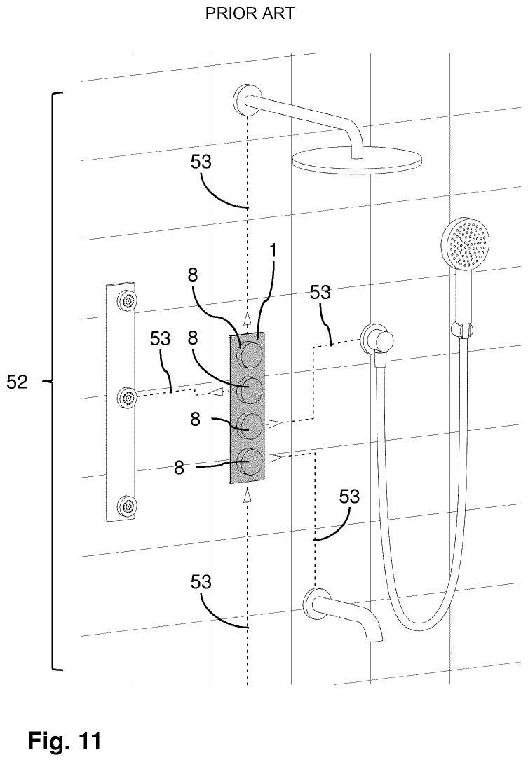

FIG. 11 shows a sanitary installation, denoted overall by 52, in accordance with the prior art. The sanitary installation 1 forms water routes 53 which are routed here by way of example to a shower head, a hand shower, a tub drain and a massage unit. Different numbers and/or types of water outlets can be configured in the case of further exemplary embodiments.

The actuating device 1 which can be seen in FIG. 11 has a plurality of actuating elements 8 which serve to switch on and off the individual water routes 2, in order to conduct the water outflow selectively via individual or several water outlets. In the case of the example of FIG. 11, the actuating elements 8 are arranged in a linear manner, but can also be arranged, for example, in an annular manner or, more generally, on a curve.

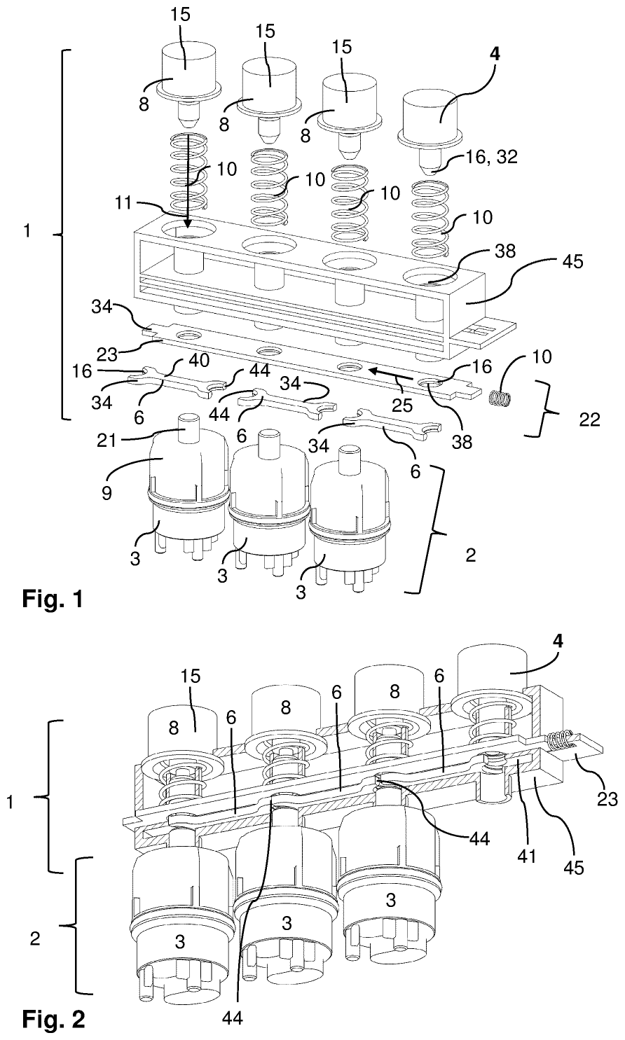

FIGS. 1 to 9 and 10A-10I show a first actuating device 1 according to the invention for use in a sanitary installation 1, similar to that of FIG. 11, but with only three switchable water routes 53. An actuating device 1 according to the invention can therefore be used to actuate a valve arrangement 2 with a plurality of valves 3, which valve arrangement 2 is arranged below it and/or forms one structural unit with it (cf. FIGS. 1 and 2).

The actuating device 1 has a plurality of actuating elements 8 which can be adjusted between a starting position 29 (OFF position) and an actuating position 30 (ON position). The valve arrangement 2 correspondingly has a plurality of valves 2 which in each case switch a water route 2.

The embodiment according to FIG. 1 shows a linear arrangement of three valves 3 which are configured in each case as self-closing touch valves 9. An associated actuating element 8 is provided for each of the three valves 3, by way of which associated actuating element 8 the respective valve 3 can be opened, with the result that water can flow from a common inlet which supplies all the valves 3 through the respectively open valve 3, in order to pass from there to an associated water outlet 2 (cf. FIG. 11 by way of example in this regard).

The three actuating elements 8 (and the further release actuating element 4) are configured in each case as a pushbutton 15 and can be deflected counter to the restoring force of a respective restoring element 10. By way of pressing of a respective one of the actuating elements 8 in the actuating direction 11 which is illustrated in FIG. 4, an activation force can be transmitted to or exerted on a respective actuating element 21 (cf. FIG. 1) of the associated valve 3, with the result that the actuated valve 3 can be transferred into an open position 24, in which water can flow through the valve 3.

Each of the three actuating elements 8 is assigned a locking element 23, namely the global locking element 23 which is shown in FIG. 1. As will still be explained in more precise detail, this locking element can be transferred by a separate release actuating element 4 (on the far right in FIG. 1) from a locking position 26 (cf. FIG. 5) into a release position 27 (cf. FIG. 4). The release actuating element 4 serves here as a global STOP button, by way of which a water flow through one of the valves 3 can be stopped at any time, by the respective locking state of the relevant actuating element 4 being canceled by way of actuation of the release actuating element 4, with the result that the actuating element 4 can then return automatically into the starting position 29, and the actuated valve 3 can correspondingly close automatically.

The actuating device 1 of FIG. 1 has, furthermore, a blocking part which, in the case of the example of FIG. 1, consists of three separate locking elements 6 which are configured in each case as a displacement part 34 and can be displaced into respective blocking positions 5 (cf. FIG. 5).

In addition, the actuating device 1 also comprises a global locking element 23 which is likewise configured as a displacement part 34. Both the global locking element 23 and the three blocking elements 6 are guided in respective guides of a guide apparatus 45 of the actuating device 1. Therefore, these elements can be displaced in a linear manner on respective displacement faces 41 in respective planes which run precisely orthogonally with respect to the common actuating direction 11 of the actuating elements 8.

As can be seen in FIG. 1, the individual blocking elements 6 have corresponding contact faces 44, via which activation forces can be transmitted, with the result that each of the three blocking elements 6 can push a respectively adjacent one of the blocking elements 6. In FIG. 5, for instance, the left-hand blocking element 6 thus pushes the blocking element 6 which is adjacent on the right-hand side, and this in turn pushes the blocking element 6 to the far right, with the result that, driven by way of the actuating movement 17 of the left-hand actuating element 8, the three blocking elements 6 move together to the right in the blocking movement direction 12 into their respective blocking positions 5 in FIG. 5. This blocking movement direction 12 runs precisely transversely with respect to the actuating direction 11 of the actuating elements 8.

In addition, the three blocking elements 6 are guided in a linear manner by way of the guide apparatus 45 in such a way that movements of the blocking elements 6 in the actuating direction 11 are prevented.

As the view of FIG. 2 shows, both the locking element 23 and the blocking elements 6 configure respective through-passage windows 38, through which the actuating elements 8 can be activated and can therefore act on the adjusting elements 21 of the respective valves 3. Furthermore, it can be seen in FIG. 2 that the locking element 23 can be deflected counter to the restoring force of a restoring element 10.

The actuating device 1 is configured in such a way that each of the three valves 3 can be opened by the respectively associated actuating element 8. By the respective blocking element 6, furthermore, each of the three actuating elements 8 (and therefore the associated valve 3) can be blocked, it no longer currently being possible for an instantaneously blocked actuating element 8 to be activated by way of pressing if one of the actuating elements 8 is locked in an actuating position 30 by way of the associated locking element 23, as is illustrated in FIG. 5 for the left-hand actuating element 8.

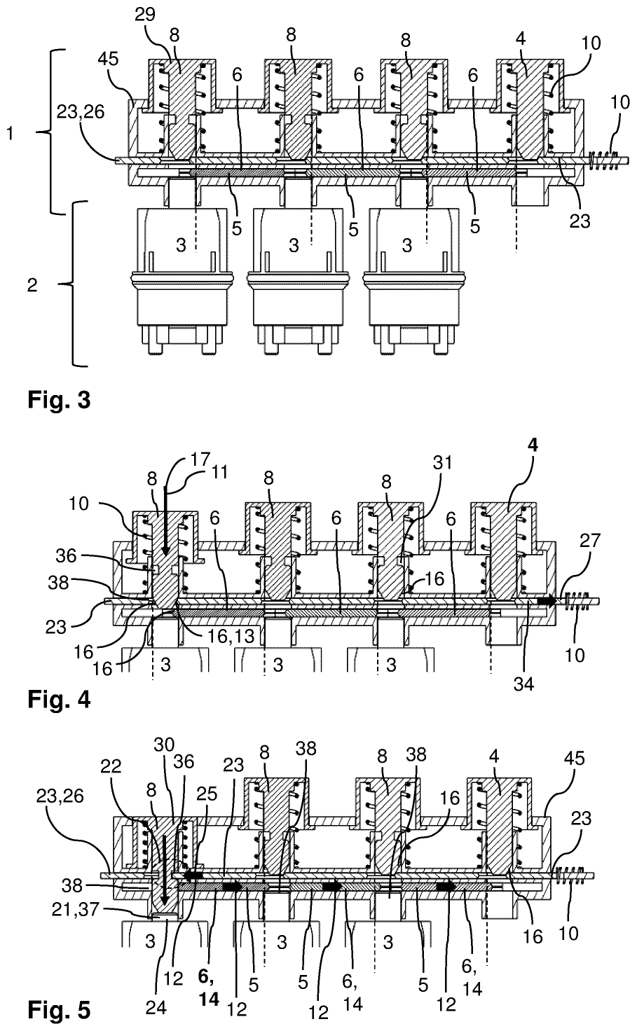

The method of operation of the actuating device 1 can be illustrated clearly on the basis of FIGS. 3 to 9 and 10A-10I: here, FIG. 3 shows the starting situation, in which all four restoring elements 10 of the actuating elements 8 are completely deflected, with the result that the respective actuating elements 8 are situated in a respective uppermost position (off position/starting position 29).

In FIG. 4, the left-hand actuating element 8 is then activated manually by an actuating movement 17 in the actuating direction 11 which is shown. The left-hand actuating element 8 which is of identical configuration to the further actuating elements 8 has a cylindrical basic shape, with a peripheral oblique face 16 at the lower end, which oblique face 16 configures a deflecting element 13 or run-on slope 32, in order to deflect the actuating force, exerted during actuation, into the plane, in which the blocking elements 6 move. Furthermore, it can be seen in FIG. 4 that a peripheral groove is configured in a middle section of the actuating element 8, which peripheral groove configures a recess 36 and, as a result, defines a holding projection 31. Merely the outermost right-hand actuating element 8 which serves as a release actuating element 4 does not have a holding projection of this type.

As FIG. 4 shows, the oblique face 16 of the left-hand actuating element 8 first of all abuts a corresponding oblique face 16 which is configured at the upper edge of a through-passage window 38 which for its part is configured in the locking element 23 (cf. FIG. 1). Therefore, the actuating element 8 transmits the actuating force by the deflecting element 13 to the locking element 23, and therefore displaces the latter to the right (cf. the block arrow in FIG. 4), with the result that the locking element 23 is deflected to the right counter to the restoring force of the associated restoring element 10.

In the case of the further downward movement of the actuating element 8 which is then made possible (that is to say, released) by way of the side movement of the locking element 23, the deflecting element 13 next abuts a further oblique face 16 which is configured at the left-hand upper edge of the left-hand blocking element 6 (cf. FIG. 1). As a result, the first left-hand blocking element 6 is displaced to the right (in FIG. 5), as a result of which the through-passage window 38 which is configured in the guide apparatus 45 (on the far left in FIG. 5) is released. As a result, the left-hand actuating element 8 can then transmit the actuating force to the adjusting element 21 of the first left-hand valve 3, in order to open this valve 3.

In other words, a blocking element 6 of the actuating device 1 is therefore moved here into the blocking position 5 shown in FIG. 5 by way of actuation of the valve 3 with the aid of the actuating element 8 in the actuating direction 11. This is because the displacement of the first blocking element 6 brings about a further displacement of the further two blocking elements 6 into the respective blocking positions 5 which are shown in FIG. 5. In the situation which is shown in FIG. 5, the first blocking element 6 blocks the through-passage window 38 which is assigned to the second actuating element 8, and the second blocking element 6 blocks the through-passage window 38 which is assigned to the third (from the left) actuating element 8. This achieves a situation where an actuation of the two remaining valves 3 and 3 is blocked as soon as the blocking elements 6 are situated in the blocking positions 5 which are illustrated in FIG. 5.

It can be seen in FIG. 5, furthermore, that, as a result of the downward pressing of the first actuating element 8, its recess 36 (cf. FIG. 4) has been conveyed into the level of the locking element 23. Driven by way of the restoring element 10, the locking element 23 therefore moves automatically in a self-acting manner to the left in the situation which is shown in FIG. 5, and engages into the recess 36 in a positively locking manner. The valve 3 can be held by way of this locking mechanism 22 in the open position 24 which is shown in FIG. 5. This is because an automatic return into the uppermost position is prevented for the left-hand actuating element 8 for as long as the locking element 23 remains in the locking position 26 which is illustrated in FIG. 5.

In order to then return the locking element 23 into the releasing position 27 which is illustrated in FIG. 4 and in which the left-hand actuating element 8 was still displaceable along the actuating direction 11, the fourth release actuating element 4 can then be actuated, as illustrated in FIG. 7. This actuating element 8 also has an oblique face 16 at its lower end, and can therefore displace the locking element 23 to the right back into the release position 27 shown in FIG. 7 in the case of actuation along the actuating direction 11.

As a result of the actuation of the first left-hand valve 3 with the aid of the associated actuating element 8, the locking elements 6 can therefore be displaced into their respective blocking positions 5 in the situation of FIG. 5. In this case (cf. FIG. 5), an actuation of the two other valves 3 is blocked/locked, since, even in the case of actuation, for instance, of the second actuating element 8, the latter can be advanced only as far as the first blocking element 6, a displacement of the first blocking element 6 to the left then being prevented, since this movement of the blocking element 6 is blocked by way of the first locked actuating element 8 (namely precisely when the blocking element 6 is situated in the ON position 37 which is shown in FIG. 5 in which the valve 3 is open).

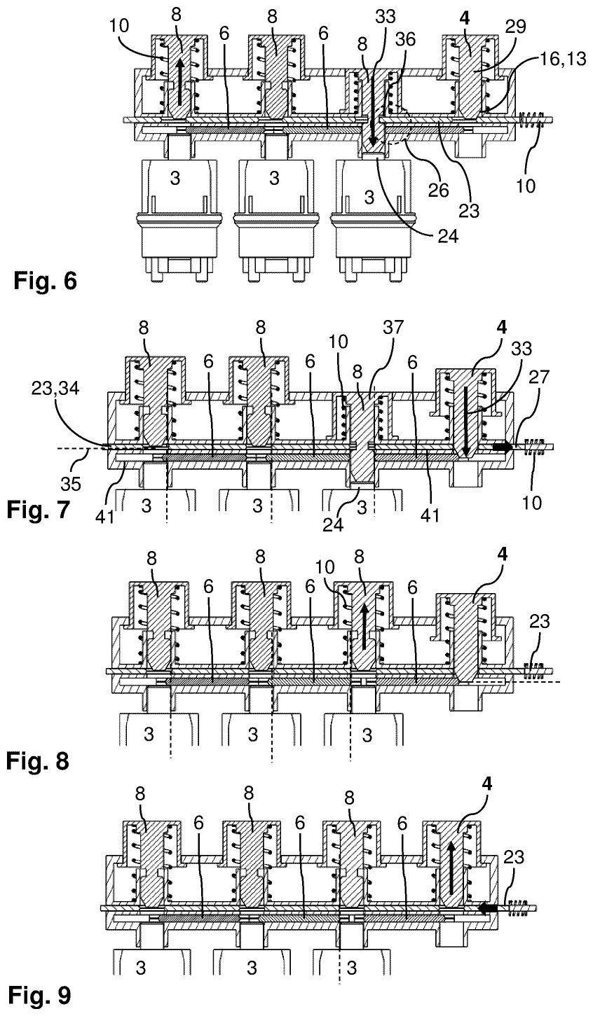

It can be seen in FIG. 5, furthermore, that the lower oblique face 16 of the fourth actuating element 4 not only bears against a corresponding oblique face 16 of the locking element 23, but rather also the lower oblique face 16 of the third actuating element 8. The same applies to the lower oblique face 16 of the second actuating element 8. Therefore, even as a result of actuation of these non-activated actuating elements 8 in the actuating direction 11, the locking element 23 can be transferred into the releasing position 27. As a consequence, as shown in FIG. 6, the first actuating element 8 can then return automatically into the upper position (by the restoring force of the restoring element 10), as a result of which the first valve 3 can close again (automatically).

If the third actuating element 8 is then pressed downward further in the direction of the actuating direction 11, the situation which is illustrated in FIG. 6 arises, in which situation the locking element 23 engages into the recess 36 of the third actuating element 8 in a manner which is again driven by way of the associated restoring element 10, and thus holds the third valve 3 in the open position 24 which is shown. The actuating device 1 is therefore configured in such a way that, by way of actuation of a currently closed valve (here, the third valve 3), another valve 3 (here, the first valve 3) which is currently being held in the open position 24 by the locking mechanism 22 (cf. FIG. 5) can be released. Here, each of the four actuating elements 8 can be actuated as a release actuating element 4, in order thus to release a valve 3, currently locked in the open position 24, of the valve arrangement 2 by a respective release movement 33.

It can be seen in FIG. 8 that the locking state of the third actuating element 8 (cf. FIG. 6) could be released by way of actuation of the fourth actuating element 8 (that is to say, of the separate release actuating element 4; cf. FIG. 7), with the result that this locked actuating element 8 then moves upward in FIG. 8, driven by way of the associated restoring element 10, and therefore makes automatic closing of the third valve 3 possible. If, as illustrated in FIG. 9, the fourth actuating element 8/the separate release actuating element 4 is then let go, it also returns into the upper position, as a result of which a starting situation which is similar to that illustrated in FIG. 3 is again reached.

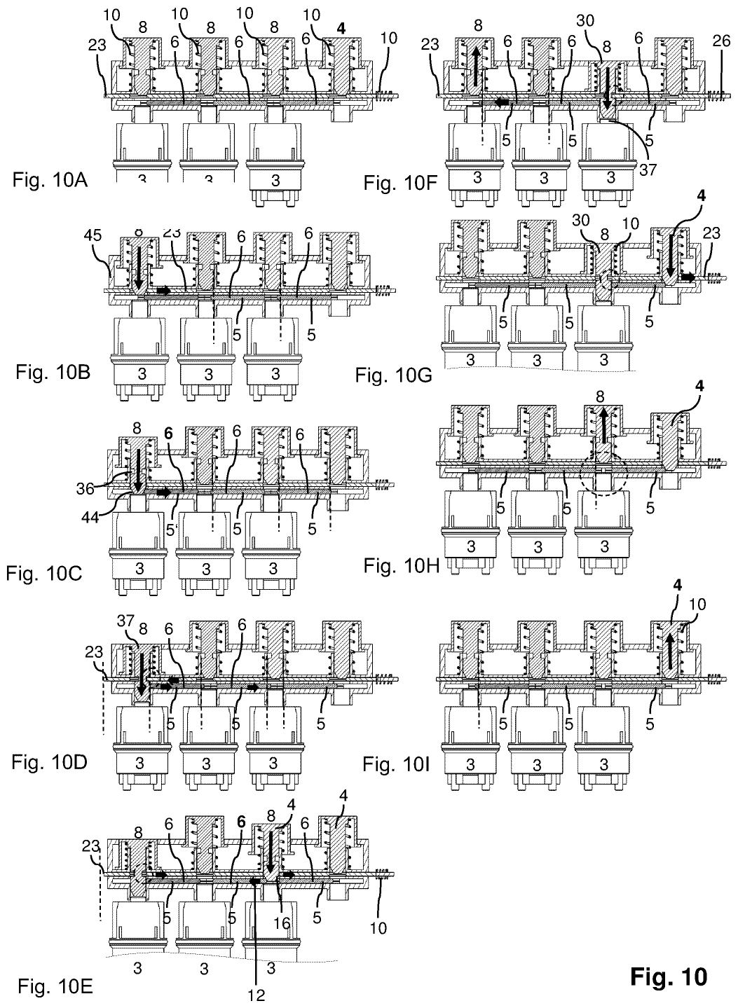

FIGS. 10A-10I once more shows a complete activation series, FIG. 10A showing the starting position, and the left-hand actuating element 8 being activated first of all in FIG. 10B. After this has moved both the locking element 23 and the first blocking element 6 to the right, the first actuating element 8 opens the left-hand valve 3 (cf. FIG. 10D). Here, the locking mechanism 22 again ensures that, in FIG. 10D, the locking element 23 locks the left-hand actuating element 8 in the ON position 37 which is shown. This locking state is released in FIG. 10E by way of actuation of the third actuating element 8 (which is therefore currently used as a release actuating element 4), since it conveys the locking element 23 to the right back into the releasing position 27. Here, the activation force which is exerted on the actuating element 8 is deflected with the aid of the deflecting element 13 and is used to compress the compression spring 10 which loads the locking element 23.

As a result of the release of the locking state of the left-hand actuating element 8, this again moves automatically upward (FIG. 10F) and, after a further downward movement of the third actuating element 8, the locking element 23 returns into the locking position 26, in order thus then, as shown in FIG. 10F, to fix the third actuating element 8 in the actuating position 30 (valve 3 is correspondingly in the ON position 37). The fixing state of the actuating element 8 is subsequently released by way of actuation of the separate release actuating element 4, as shown in FIG. 10G. As a result, the valve 3 can again close automatically, as shown in FIG. 10H. Finally, the release actuating element 4 also returns into its starting position, driven by way of the associated restoring element 10 (cf. FIG. 10I).

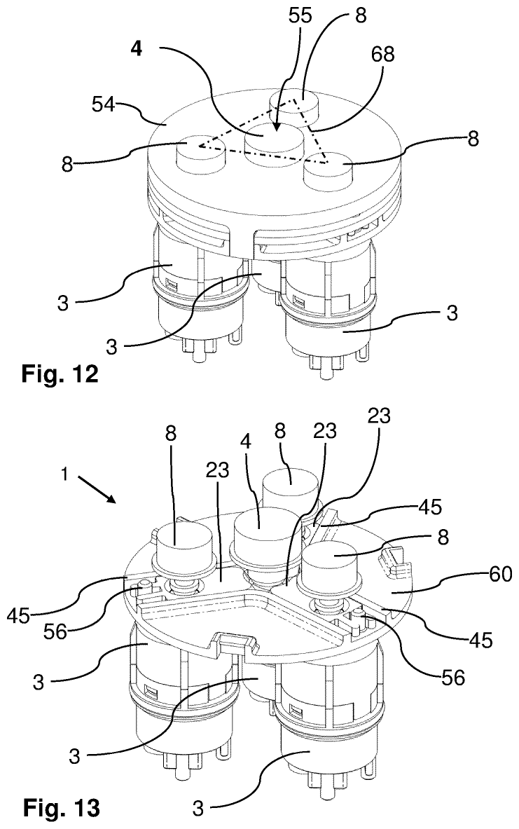

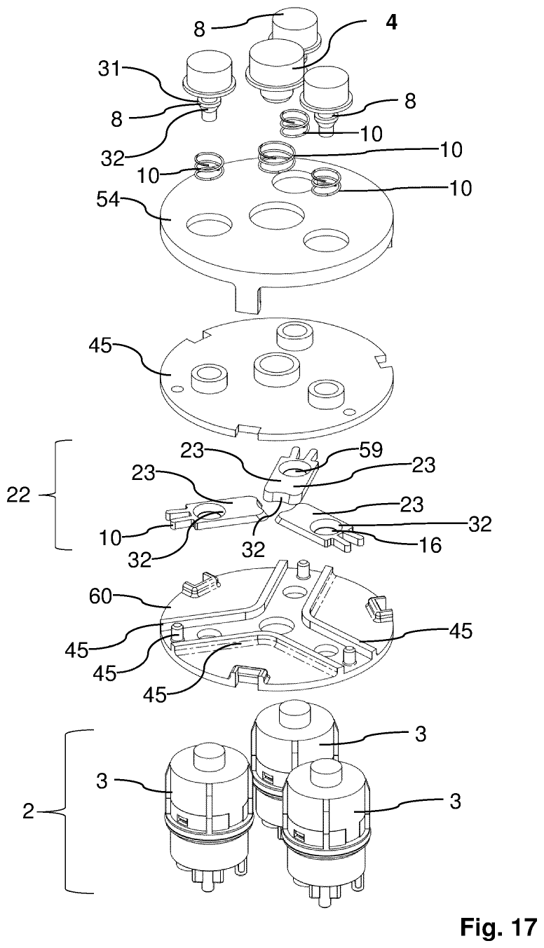

FIGS. 12 to 17, 18A-18D, and 19A-19D show a second exemplary embodiment according to the invention. Components and functional units which are functionally and/or structurally similar or identical to the preceding exemplary embodiments are denoted by way of the same designations and are not described again separately. The comments in respect of FIGS. 1 to 9 and 10A-10I therefore apply correspondingly to FIGS. 12 to 17, 18A-18D, and 19A-19D. As can be seen, this example has three actuating elements 8 and a centrally arranged release actuating element 4, each of the three actuating elements 8 in each case being assigned a dedicated locking element 23 (cf. FIG. 17).

The second exemplary embodiment according to FIGS. 12 to 17, 18A-18D, and 19A-19D therefore differs from the preceding exemplary embodiment in that a plurality of separate locking elements 23 are configured which are mounted in a radially displaceable manner in relation to a center 55 of the apparatus 1 (cf. FIG. 12). As is seen in FIG. 13 and FIG. 17, the locking elements 23 are guided on a base plate 60 by respective guide means 45. As a result, the locking elements 23 can be moved to and fro in each case only in radial directions.

In the case of further exemplary embodiments, the locking elements 23 can be capable of being moved along other tracks, in particular, for example, can also be pivotable about a pivot axis in a pivoting plane. Pivoting of this type can also be achieved by way of lateral displacement as a result of activation of a release actuating element 4.

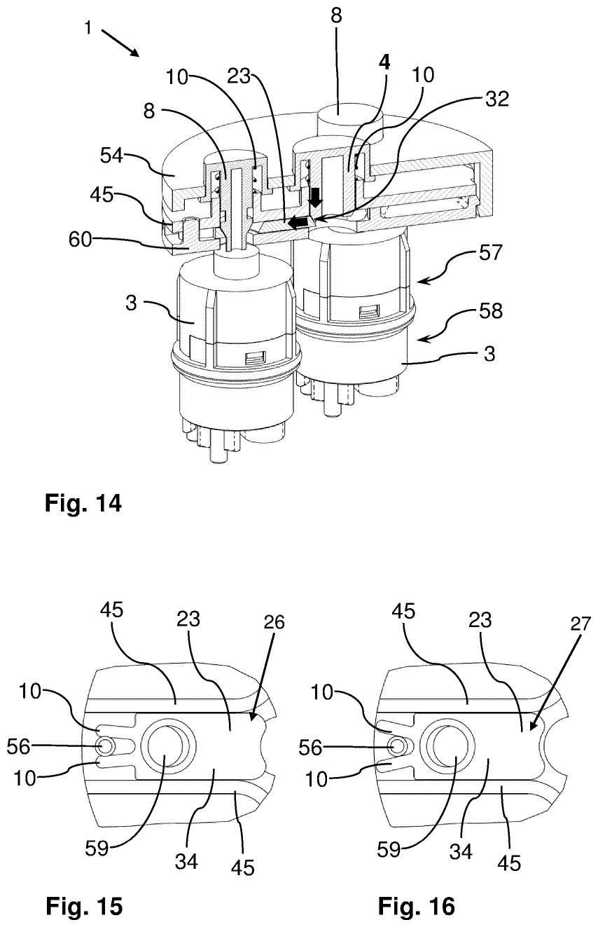

It becomes clear as a result of a comparison of FIG. 15 with FIG. 16 that the restoring elements 10 which are assigned to each locking element 23 are formed in one piece on the respective locking element 23 and ensure a restoring movement into the locking position 26 (FIG. 15). Here, the restoring elements 10 interact with matching projections 56 which form a respective abutment. In order to move the respective locking element 23 into the release position 27 which is shown in FIG. 16, the centrally arranged release actuating element 4 (cf. FIG. 14) acts directly on the respective locking element 23 via the run-on slope 32 which is illustrated in FIG. 14: if the release actuating element 4 is pressed downward, it displaces all three locking elements 23 at the same time radially outward, counter to the restoring force of the respective restoring element 10 (cf. the block arrows in FIG. 14).

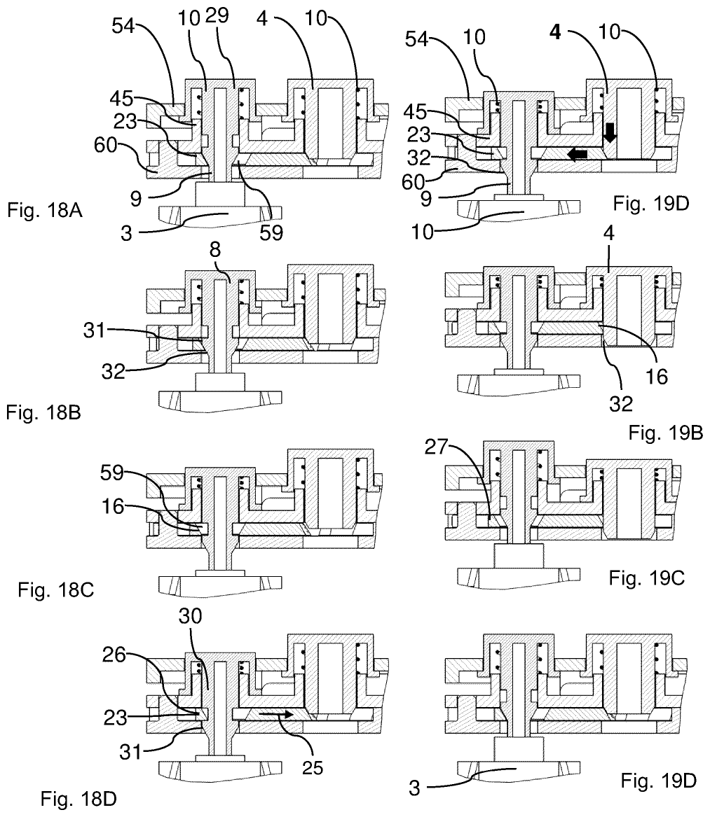

FIGS. 18A-18D show the movement sequence in the case of an actuating movement of the actuating element 8 from top to bottom: the run-on slope 32 on the actuating element 8 first of all displaces the locking element 23 here (second image from the top), until the locking element 23 can engage behind the holding projection 31 of the actuating element 8 (third and fourth image from the top). The restoring element 10 (cf. FIG. 15) then moves the locking element 23 into its locking position 26 (fourth image from the top: in this regard, cf. also Figure with the result that the actuating element 8 is fixed in its actuating position 30 (lowermost image).

The remaining actuating elements 8 can then be moved in the same way into their actuating position, since mutual blocking is not configured in the case of this second exemplary embodiment. If all the actuated actuating elements 8 are to be restored into their respective starting position 29, the centrally arranged release actuating element 4 (cf. FIG. 12) has to be actuated.

FIGS. 19A-19D show the sequence of this movement of the release actuating element 4 from top to bottom: it can be seen that the release actuating element 4 likewise has a run-on slope 32, by way of which all the locking elements 23 can be displaced in the respectively radial direction to the outside (first image from the top in FIG. 19: in this regard, cf. also FIGS. 14 and 17), until the associated actuating elements 8 are free again (that is to say, are no longer locked) (second image from the top). The actuating elements 8 can then return automatically into the starting position 29, driven by way of the respective restoring element 10 (third image from the top). Here, the run-on slope 32 interacts with corresponding oblique faces 16 on the locking elements 23. A dedicated restoring element 10 also moves the release actuating element 4 back again into its starting position 29 as soon as it is let go.

If it is to be prevented that two actuating elements 8 can be pressed at the same time, pivotable blocking elements 6, in particular configured as pivotable segments, can also be used, for example, as has already been explained in relation to the first exemplary embodiment using the blocking elements 6 there (cf. FIG. 1).

The valves 3 of all exemplary embodiments can have a pilot valve 57 and a main valve 58 in a manner known per se (cf. FIG. 14). Here, a pressure chamber can be filled and emptied again by way of the pilot valve 57 with an operating pressure which prevails at the valve 3. Here, an internal pressure in the pressure chamber determines a switching position of the main valve 58. Therefore, an actuating force of the valve 3 can be substantially lower than a force for carrying out the switching movement of the main valve 58, which explains the advantage of using a pilot valve 57. The mechanism of the actuating device 1 can therefore be designed for these lower forces which are necessary for actuating the pilot valve 57.

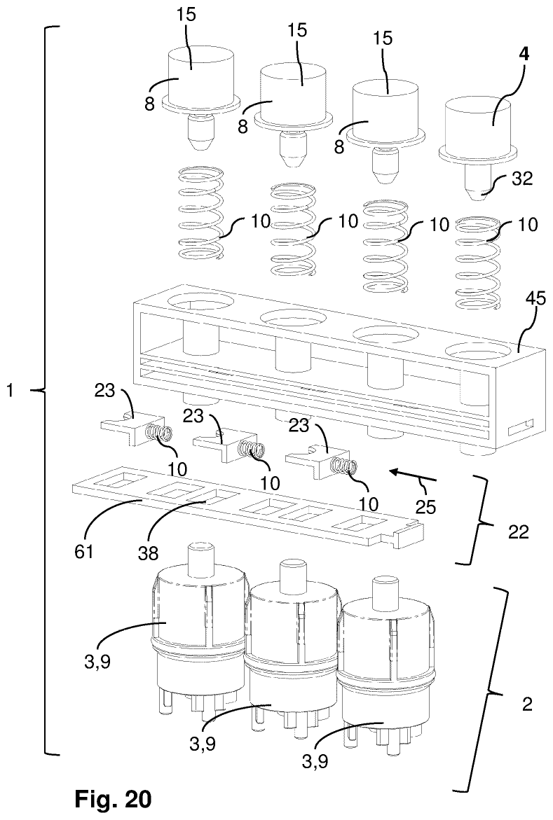

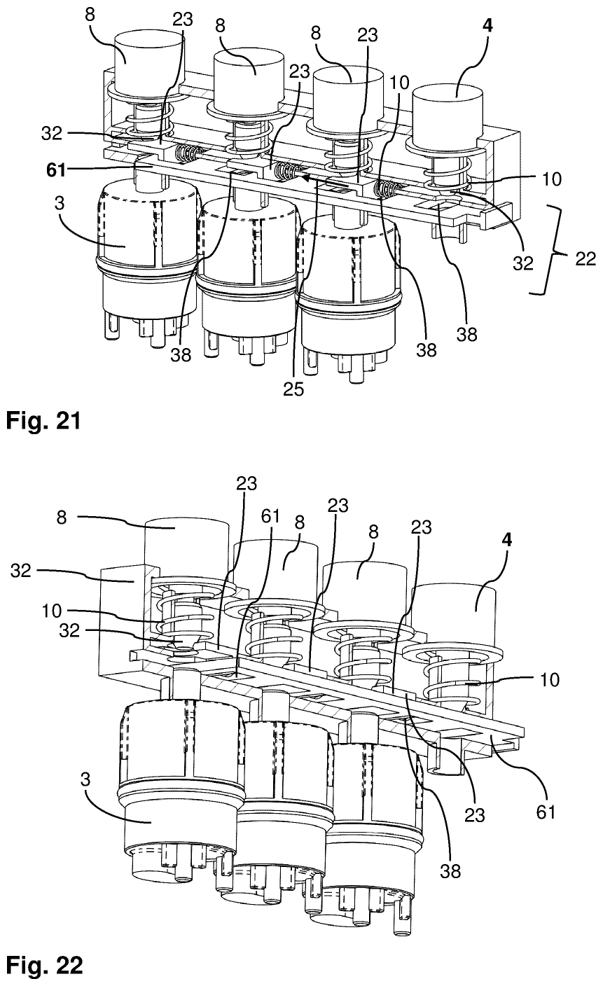

FIGS. 20 to 22 and 23A-23H finally show a third exemplary embodiment. In the case of this actuating device 1 according to the invention, three actuating elements 8 are configured for actuating a respective valve 3. Each of the three actuating elements 8 has a separate locking element 23 here, and each of the locking elements 23 has a dedicated associated restoring element 10. As is indicated in FIG. 20, the three locking elements 23 are mounted here such that they can be displaced along a common locking direction 25. As in the case of the preceding examples, the actuating elements 8 can also be transferred here in each case from a starting position 29 into an actuating position 30, and, after transfer into the respective actuating position 30, each of the at least two actuating elements 8 is fixed/locked in the actuating position 30 by the locking mechanism 22 automatically by way of the respectively associated locking element 23.

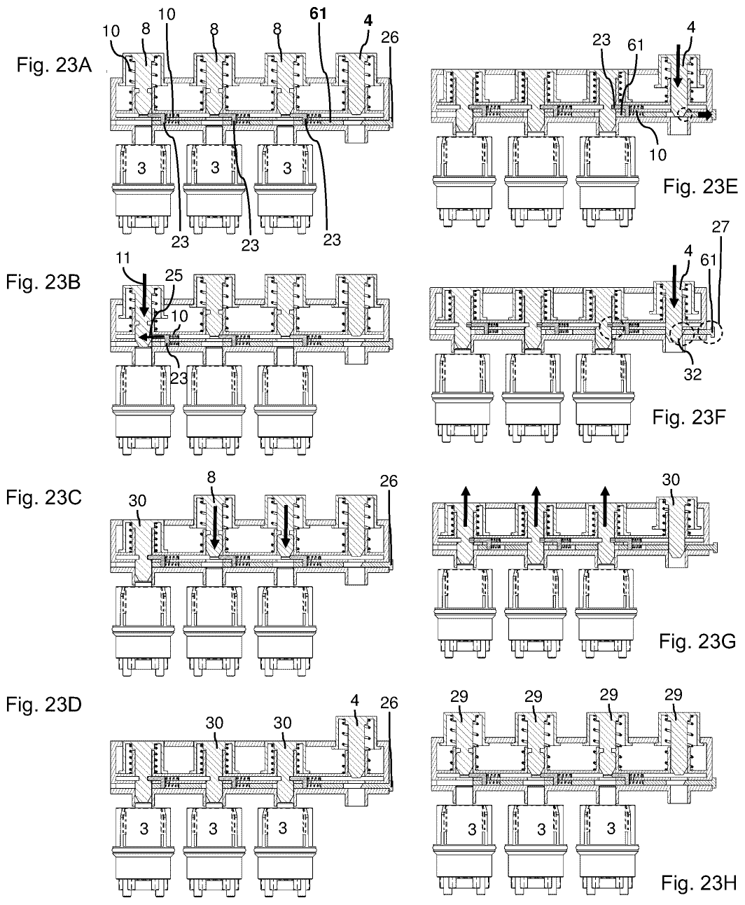

Unlike in the case of the second exemplary embodiment, the locking elements 23 are not activated directly by the separate release actuating element 4, however, but rather via a global release element 61 which for its part can be activated via a run-on slope 32 on the release actuating element 4 by way of actuation of the release actuating element 4. In addition, in the case of the example of FIG. 20, no blocking functionality at all is configured, with the result that, as illustrated in FIG. 23D, a plurality of the actuating elements 8 can also be locked in the actuating position 30.

Here, the release element 61 has respective through-passage windows 38, into which the locking elements 23 engage (cf. FIGS. 22 and 23A-23H). As a result, the release element 61 can drive the locking elements 23 when the release element 61 is displaced by the release actuating element 4 (cf. FIGS. 23E-23H). Here, the through-passage windows 38 are configured to be so large that a relative movement is possible between the release element 61 and the locking elements 23 in the direction of the locking movement 33.

In part images FIGS. 23A-23C explains how an actuated actuating element 8 is fixed automatically in the actuating position 30 by the locking mechanism 22. If additional actuating elements 8 are activated, they likewise pass into a locked actuating position 30 (cf. FIG. 23D). By way of actuation of the release actuating element 4, the release element 61 can be transferred from the locking position 26 (FIGS. 23C-23D) into the release position 27 (FIG. 23F), the actuating force being transmitted via the run-on slope 32 on the release actuating element 4 to the release element 61, in order to displace the latter transversely with respect to the actuating direction 11 and counter to the locking direction 25 (cf. FIG. 23B) into the release position 27.

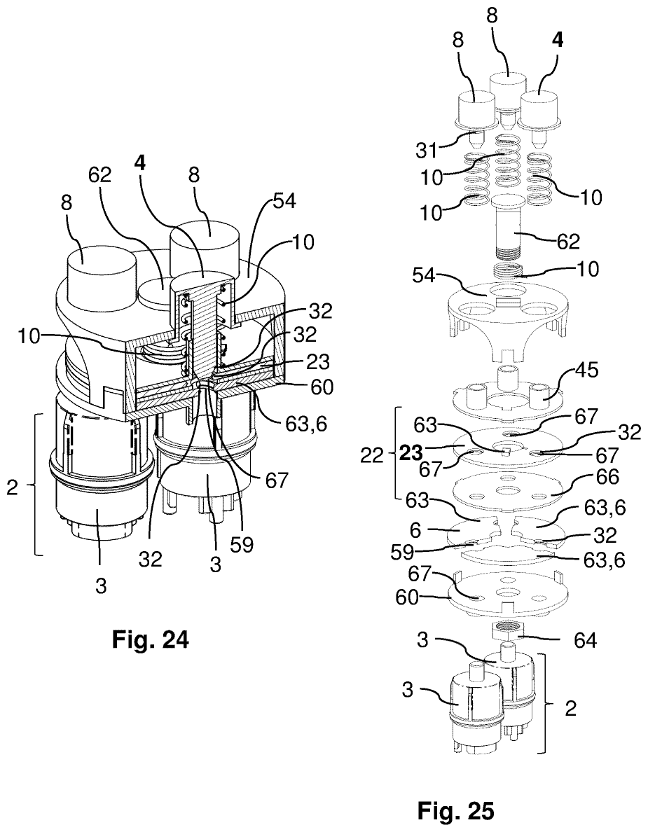

FIGS. 24 and 25 finally show a fourth embodiment of an actuating device 1 according to the invention which is of similar configuration to those from FIG. 12 and FIG. 17, but only with two valves 3 and also not with three separate locking elements 23, but rather with a single disk-shaped locking element 23 which is mounted as a pivoting part such that it can be rotated about an axis which corresponds to the longitudinal axis of the fastening means 62.

The actuating device 1 of FIGS. 24 and 25 has a covering 54 which holds the two actuating elements 8 and an additional release actuating element 4. Here, the actuating movement of the elements 8 and 4 is specified by way of a guide apparatus 45.

The locking mechanism 22 comprises a global locking element 23 and a corresponding counter-element 66. The locking element 23 and the counter-element 66 in each case have through holes 67, the size of which is adapted to the actuating elements 8 which engage through the through holes 67 (cf. FIG. 24). The position of the locking element 23 is therefore fixed when the actuating elements 8 engage into the holes 67.

The locking element 23 can be rotated/pivoted counter to the counter-element 66, to be precise counter to the restoring force of the restoring element 10 which can be seen in FIG. 24 below the fastening element 62.

Three blocking elements 6 which are configured as segments 63 are provided below the locking mechanism 22. The segments 63 can likewise be moved in a pivoting movement (approximately about the longitudinal axis of 62).

A hole 59 is configured in each case between adjoining segments 63. If the adjoining segments 63 of a hole 59 are at a maximum spacing from one another, the hole 59 is greater than the diameter of the associated actuating element 8, 4. The respective actuating element 8, 4 can then be introduced into the hole 59. If, in contrast, the adjacent segments 63 of a hole 59 are at a minimum spacing from one another, the hole 59 is smaller than the diameter of the associated actuating element 8, 4. The actuating element 8, 4 cannot then be introduced into the hole 59, with the result that the respective actuating movement is blocked.

If one of the actuating elements 8 is pressed into its actuating position 30, the adjacent segments 63 are displaced on account of the run-on slopes 32 which are configured on them (cf. FIG. 24). As a result, the remaining holes 59 of the blocking elements 6 are decreased in size, with the result that the other actuating element 8 no longer fits through them. It is therefore not possible in the case of the actuating device 1 of FIGS. 24 and 25 for the two actuating elements 8 to be actuated at the same time, on account of the blocking action which is produced by way of the pivotable segments 63.

The actuating device 1 of FIGS. 24 and 25 finally has a base plate 60 which holds the guide apparatus 45, the disk-shaped locking element 23, the disk-shaped counter-element 66 and the disk-shaped segments 63 in a stack arrangement. The fastening means 62 and a lock nut 64 hold the stack arrangement together here. The two valves 3 are fastened to the main plate 60. If one of the two actuating elements 8 is pressed out of its starting position 29 downward to such an extent that it engages through the holes 59 and 67, the associated valve 3 is actuated.

As has been mentioned, the global locking element 23 is mounted such that it can be rotated about the fastening means 62 (cf. FIG. 25). A play limiting means 63 which interacts with an associated recess on the guide apparatus 45 (or on another non-rotational part) limits the available pivoting angle of the locking element 23 here. Here, said restoring element 10 defines a rest position of the locking element 23.

The actuating elements 8 and 4 have respective run-on slopes 32 (cf. FIG. 24), with the aid of which the locking element 23 is pivoted in the case of an actuating movement from the rest position. Here, these run-on slopes 28 interact with matching run-on slopes 32 on the locking element 23 (cf. FIG. 25). If one of the two actuating elements 8 is actuated further, the locking element 23 engages behind a holding projection 31 on the actuated actuating element 8, as a result of which the actuating element 8 is locked and therefore a return movement is prevented.

In contrast, the release actuating element 4 does not have a holding projection 31 of this type, and therefore also cannot be locked.

If the release actuating element 4 is actuated in a situation of this type, the locking element 23 is deflected from the locking position 26 into its release position 27. This leads to the locking state of the actuating element 8 which was previously still locked being canceled, with the result that it is moved back into its starting position 29, driven by way of the associated restoring element 10. As a result, the blocking action of the segments 63 is also canceled, with the result that the release actuating element 4 can also pivot them. Therefore, the other actuating element 8 can subsequently be actuated, in order thus to switch the second one of the two valves 3.

In summary, in order to improve the operating properties of an actuating device 1 for releasing water routes 53 of a sanitary installation 52, it is proposed that the actuating device 1 has a locking mechanism 22 on the basis of at least one movable locking element 23, by way of which locking mechanism 22 at least two actuating elements 8 of the apparatus 1 which serve to actuate associated valves (3) can be locked releasably in a respective actuating position 30, and that the actuating device 1 has a separate release actuating element 4, by way of which a locking state of each of the remaining at least two actuating elements 8 can be released.

### LIST OF REFERENCE NUMBERS

1 actuating device (for actuating 3)
2 valve arrangement
3 valve (of 2)
4 release actuating element
blocking position
6 blocking element
8 actuating element (for actuating, in particular for opening 3)
9 touch valve
restoring element
11 actuating direction
12 blocking movement direction
13 deflecting element (for turning from 11 into 12)
14 blocking movement
15 pushbutton
16 slope face/opposing slope
17 actuating movement (of 8)
21 actuating element (for opening 3)
22 locking mechanism
23 locking element
24 open position (of 3)
25 locking direction
26 locking position (of 23)
27 release position (of 23)
29 starting position (of 8)
30 actuating position (of 8)
31 holding projection
32 run-on slope
33 locking movement (of 23)
34 displacement part
35 locking plane (34 moves in it)
36 recess (in 8)
37 ON position (of 8)
38 through-passage window (through which 8 can be actuated, unless blocked by 6)
40 supporting face (of 6 for sliding on 41)
41 displacement face
44 contact face
45 guide apparatus
52 sanitary installation
53 water routes
54 covering
55 center
56 projection
57 pilot valve
58 main valve
59 hole
60 base plate
61 release element
62 fastening means
63 segment
64 lock nut
65 play limitation means
66 counter-element
67 through hole (in 23)
68 polygon

1. An actuating device (1), comprising:
at least two actuating elements (8) configured for actuating at least two valves (3) of a valve arrangement (2),
a locking element (23) assigned to each of the at least two actuating elements (8), the locking element being configured to lock the respective actuating element (8),
a separate release actuating element (4) configured for transferring the locking element (23) from a locking position (26) into a release position (27),
each said actuating element (8) having a holding projection (31) between a free end thereof and a recess (36) which interacts with the locking element (23), by which holding projection (31) the locking element (23) is deflectable, and
each said actuating element (8) being guided axially in a region of the respective holding projection (31).

2. The actuating device (1) as claimed in claim 1, wherein the recess (36) comprises a peripheral groove.

3. The actuating device (1) as claimed in claim 1, wherein the locking element (23) comprises a global locking element (23) which is configured to lock all of the at least two actuating elements (8).

4. The actuating device (1) as claimed in claim 1, wherein the locking element comprises respective separate locking elements (23), each of the at least two actuating elements (8) being assigned a respective one of the separate locking elements (23), and the release actuating element (4) is configured to transfer all of the locking elements (23) into a respective release position (27).

5. The actuating device (1) as claimed in claim 4, wherein the release actuating element (4) acts directly on the locking elements (23) via a run-on slope (32), in order to transfer the locking elements (23) into the respective release positions (27).

6. The actuating device (1) as claimed in claim 4, wherein each of the separate locking elements (23) is transferrable by a global release element (61) into a respective release position (27).

7. The actuating device (1) as claimed in claim 4, wherein the separate locking elements (23) are at least one of arranged radially in relation to the release actuating element (4) or displaceable in radial directions into respective release positions (27).

8. The actuating device (1) as claimed in claim 1, wherein the actuating elements (8) are transferrable in each case from a starting position (29) into an actuating position (30), and each of the at least two actuating elements (8) is fixable or fixed in the actuating position (30) automatically by the associated locking element (23) after transfer into the respective actuating position (30) to prevent an automatic return of the fixed actuating element (8) into the starting position (29).

9. The actuating device (1) as claimed in claim 1, wherein each of the at least two actuating elements (8) are assigned a respective blocking element (6), by which an actuating movement (17) of the respective actuating element (8) is temporarily blockable, such that, as soon as one of the at least two actuating elements (8) is situated in an actuating position (30), actuation of all the other ones of the at least two actuating elements (8) is blocked.

10. The actuating device (1) as claimed in claim 1, wherein each of the blocking elements (6) is transferrable into a respective blocking position (5) using the release actuating element (4), and the blocking elements (6) are in mutual contact and therefore an associated one of the blocking elements (6) is transferrable from the blocking position (5) into the release position by actuation of one of the at least two actuating elements (8) when none of the actuating elements (8) is currently locked via the associated locking element (23).

11. The actuating device (1) as claimed in claim 1, wherein the at least two actuating elements (8) are not blocking mutually, such that a plurality of the at least two actuating elements (8) are also simultaneously situated in an actuating position (30).

12. The actuating device (1) as claimed in claim 1, wherein the respective locking element (23) is configured to lock an associated one of the actuating elements (8) in a positively locking manner via a holding projection (31) on the respective actuating element (8), into which holding projection (31) the locking element (23) is engageable.

13. The actuating device (1) as claimed in claim 1, wherein the at least two actuating elements (8) are manually actuatable along a common actuating direction (11), and the locking element (23) is movable during the transition into a locking position (26), in a plane which runs transversely with respect to the actuating direction (11), and the locking element (23) moves in a linear manner into the respective locking position (26).

14. The actuating device (1) as claimed in claim 1, wherein a locking state of one of the actuating elements (8) by the locking element (23) is cancelable by actuation of another non-locked one of the actuating elements (8), and the actuated non-locked actuating element (8) includes a run-on slope (32), by which the locking element (23) is transferrable into a release position (27).

15. A sanitary installation (52) comprising the actuating device (1) as claimed in claim 1.

16. The sanitary installation of claim 15, wherein the sanitary installation is at least one of a shower or bath fitting.

17. The actuating device (1) as claimed in claim 4, wherein the separate locking elements (23) are mounted for displacement along a common locking direction (25).

18. The actuating device (1) as claimed in claim 4, wherein the separate locking elements (23) are pivotable about respective rotational axes into the respective locking positions (26).

19. The actuating device (1) as claimed in claim 1, wherein the respective locking element (23) is movable counter to a restoring force of a restoring element (10), from a respective locking position (26) into a respective release position (27), the respective locking element (23) fixing the associated actuating element (8) in the locked position (26).

20. The actuating device (1) as claimed in claim 9, wherein the respective blocking element (6) is transferrable from a blocking position (5) into a release position by actuation of one of the at least two actuating elements (8), and
the respective blocking element (6) is transferrable from a release position into the respective blocking position (5) by actuation of the separate release actuating element (4).
